(19) United States
(12) Patent Application Publication
(10) Pub. No.: US 2026/0043700 A1
(43) Pub. Date: Feb. 12, 2026

(54) MODULAR, HUMAN BLAST OVERPRESSURE BODY TESTING SURROGATES

(71) Applicants: Blake Muzinich, Reno, NV (US); Kyle Willens, Carson City, NV (US); Barkan Kavlicoglu, Reno, NV (US); Faramarz Gordaninejad, Reno, NV (US)

(72) Inventors: Blake Muzinich, Reno, NV (US); Kyle Willens, Carson City, NV (US); Barkan Kavlicoglu, Reno, NV (US); Faramarz Gordaninejad, Reno, NV (US)

(21) Appl. No.: 18/799,768

(22) Filed: Aug. 9, 2024

(51) Int. Cl. G01L 5/14; B33Y 10/00; B33Y 80/00; G09B 23/18

(52) U.S. Cl. CPC G01L 5/14; B33Y 10/00; B33Y 80/00; G09B 23/187

(57) ABSTRACT

The uniqueness of the presented invention is a biofidelic, metamaterial structured, integrated with wireless sensors, modular, reusable, and anatomically accurate human surrogate (for both male and female) designed for testing and evaluation of personal protective equipment (PPE), and blast environments. Structured with metamaterials, the surrogate demonstrates a biofidelic response to blast overpressure. Metamaterials tailored for blast applications manipulate properties such as wave speed, acoustic impedance, and frequency response to match human tissues with minimized complexity. Incorporating technology from wearable blast sensors, the Blast Overpressure Body (BOB) provides high-resolution, high sampling rate, and time-synchronized simulated human blast data. Its modular design allows for easy replacement of damaged parts, alternative testing scenarios, and enhanced biofidelity, increasing flexibility and reusability. The BOB is a tool for testing, evaluating, and developing PPE and weapon systems, and for research, surveillance, and mitigation of blast exposure in military, industrial, civilian, and law enforcement contexts.

### PRIORITY CLAIM

Priority is claimed on the following application: Country: Unites States of America, Application No. 63/518,991, Filed: Aug. 11, 2023, the content of which is/are incorporated herein by reference in its entirety.

This invention was made with Government support under Contract No. HT942523C0054 awarded by US Army Medical Research Acquisition Activity. The Government has certain rights in the invention.

### BACKGROUND

Explosions can cause bodily and nerve system injuries. Traumatic Brain Injury (TBI) and Post-Traumatic Stress Disorder (PTSD) are well-known blast-related injuries^{1,2}. Lung and other internal organ injuries are other types of polytrauma sustained by persons exposed to blast. Thus, evaluating PPE, blast sources, and environments for human blast exposure using surrogates may be needed to mitigate, understand, prevent, and treat blast overpressure injuries and illnesses.

There are only two^{3,4} commercialized blast-specific dummies or surrogates, and a limited number of research prototypes⁵⁻⁷ providing sensor-integrated blast overpressure data for human subjects. The two commercialized technologies, the Thoracic Surrogate³ and WIAMan⁴ (Warrior Injury Assessment Manikin) are not complete surrogate solutions for evaluating PPE, weapon systems, or blast environments. The Thoracic Surrogate focuses on the thorax or chest for PPE evaluation with a commercial off-the-shelf (COTS) vehicle impact dummy head and neck. Whereas the WIAMan was designed to evaluate occupant injury kinematics during a ground vehicle underbody blast event such as an Improvised Explosive Device (IED) explosion to improve military vehicle blast protection.

The prior art research prototypes have made progress in capturing blast-specific data but are not all-in-one solutions. These prototypes have two major deficiencies, they are not complete surrogates, e.g., are only a head that still needs to be attached to the rest of a costly crash test dummy, and they rely on costly COTS laboratory blast sensors and supporting electronics that need specialized knowledge to operate and process data.

A surrogate for testing and evaluating PPE, weapons systems, and blast environments for human blast exposure must provide accurate high-resolution blast-pressure and/or acceleration data and be a complete, anatomically correct, biofidelic, and easy-to-use solution. Prior art for human blast surrogates does not meet these requirements.

### BRIEF SUMMARY OF THE INVENTION

This invention is an anatomically correct, sensor-integrated male and female blast surrogate designed for testing and evaluating personal protective equipment (PPE), weapon systems, and environments for blast protection and exposure. The surrogate enables key measurements of pressure and/or acceleration exposure during blast events at various locations such as the skull, forehead, eyes, ears, in-brain, chest, lungs, belly, and other internal organs. This uniqueness is achieved using metamaterial engineering and three-dimensional (3D) printing techniques to produce a surrogate that mimics human blast response with minimized surrogate tissue layers and complexity.

The surrogate is equipped with sensors capable of capturing high-resolution, high sampling rate, and time-synchronized data from blast events. These sensors can integrate and capture data from additional sensors, including but not limited to acceleration, temperature, and force sensors. The modular design allows for easy and low-cost replacement of damaged parts, upgrades, or alternate modules, enhancing its reusability and customizability. The surrogate is designed to be man-portable, durable, water-resistant, wireless, and battery-powered.

In the preferred embodiment, the sensing elements and conditioning circuitry with standardized connections are connected to the main controller's jacks using standard audio cables and connectors, including but not limited to 4-pole stereo cables. These cables are fed through various channels in the surrogate, allowing for easy replacement and modularity with low noise. The sensors have standardized connector jacks to both the main controller board and sensing element boards, resulting in modular remote sensing boards that can be placed anywhere on or in the surrogate. These replaceable remote sensing element boards are powered by the main controller via two of the poles in the audio cable, with the other two poles used as ground and signal channels.

One aspect of the present invention is a modular anatomically correct male and female surrogate, comprising an anatomical head and torso, with various simulated organs and multiple pressure and/or acceleration sensors, a controller for data processing, and a power supply. The invented surrogate offers capabilities for capturing data at various locations, including in the brain, and provides an anatomically correct human form for testing and evaluating PPE and environments.

According to another aspect of the invention, the surrogate is manufactured using 3D printing techniques, including but not limited to fused deposition modeling (FDM), selective laser sintering (SLS), and stereolithography (SLA) with various materials. The 3D printed construction utilizes metamaterial engineering and/or multi-material construction to match human tissues'acoustic impedance, attenuation, and blast response concerning pressure. This approach allows low-cost production and replication of complex anatomical structures and tissues.

According to another aspect of the invention, the surrogate data from an event can be modified to more closely match human models, simulations, and cadaver reference data utilizing mathematical functions or algorithms to correct or calibrate output test data. According to another aspect of the invention, the surrogate captures multiple channels of high-resolution data while allowing easy replacement of damaged parts and enabling the data to be sent wirelessly via Bluetooth, Wi-Fi, or physical connections to different devices. Alternatively, the sensor control boards can be equipped with other onboard instrumentation, including but not limited to accelerometers, gyroscopes, thermometers, and barometers, to evaluate body kinematics and blast physics during a blast overpressure event.

According to another aspect of the invention, the surrogate is powered by an onboard battery or an external power source. The design makes it man-portable, durable, water-resistant, wireless, and battery-powered.

According to another aspect of the invention, the surrogate is designed to trigger a blast event based on sensor data, offering similar responses to human models and cadaver tests in waveform properties, and providing a rolling buffer to include pre-peak data.

According to another aspect of the invention, the surrogate's head contains an anatomically correct brain cavity designed to accommodate any brain simulant material or system.

According to another aspect of the invention, the surrogate is used for occupational blast injury assessments, collecting blast and acceleration data, replicating personnel positioning during blast events, and robustly supporting free field, enclosed space, and shock tube testing.

According to another aspect of the invention, methods for operating the surrogate include affixing the surrogate or individual components to test stands or to crash test dummy components for flexible and customizable blast testing.

According to another aspect of the invention, the surrogate is manufactured using other manufacturing techniques, including but not limited to injection molding, blow molding, casting, and thermoplastic and thermoform molding.

According to another aspect of the invention, the surrogate's modular design emphasizes the adaptability and flexibility of the system, allowing for easy replacement and customization of damaged or specific parts.

### BRIEF DESCRIPTION OF DRAWINGS

FIG. 1 is an isometric view of the BOB assembly.

FIG. 2 is a front view of the BOB assembly.

FIG. 3 is a right-side view of the BOB assembly.

FIG. 4 is a left-side view of the BOB assembly.

FIG. 5 is a backside view of the BOB assembly.

FIG. 6 is a backside cross-sectional cut view of the BOB's torso.

FIG. 7 is a left-side cross-sectional cut view of the lower portion of the BOB's head.

FIG. 8 is a right-side cross-sectional cut view of the upper portion of the BOB's head.

FIG. 9 is an isometric view of the non-in-brain pressure-sensing printed circuit board (PCB) with electrical components.

FIG. 10 is an isometric view of the in-brain pressure-sensing printed circuit board (PCB) with electrical components.

FIG. 11 is an isometric view of the main controller data acquisition printed circuit board (PCB) with electrical components.

FIG. 12 is an isometric view of the BOB assembly in an alternate embodiment where the chest cavity is open without a module present.

FIG. 13 is an isometric view of the BOB assembly in an alternate embodiment where the chest cavity contains a ribcage and lung module.

FIG. 14 is a front view of the BOB assembly in an alternate embodiment where the chest cavity contains a ribcage and lung module.

FIG. 15 is a concept of operation flow diagram of the BOB.

### DETAILED DESCRIPTION OF THE INVENTION

Persons of ordinary skill in the art will realize that the following description is illustrative only and not in any way limiting. Other instances of the invention will readily suggest themselves to such skilled persons.

The present invention is particularly useful for sensing, recording, and storing pressure and acceleration of a blast event experienced at various locations on and in a simulated human body for post-event analysis and evaluation of exposure. The BOB includes multiple pressure sensors and/or acceleration sensors and at least one activation sensor which may be, for example, a multi-axis accelerometer and/or a selected pressure sensor channel, or a plurality of pressure sensor channels. The pressure signals are conditioned and processed with a microcontroller (MCU). The amplitude and time history of sensors and at least one other sensing element to measure a parameter such as pressure and/or other sensor data is used for the calculation of a blast severity metric, such as pressure impulse. The pressure sensors can be made of various materials and/or microelectromechanical systems (MEMS) including, but not limited to, a piezoelectric, piezoresistive, capacitive, diaphragm, or strain-gage-based sensing element(s). The activation sensor may be an accelerometer(s) or may also be made using various material systems and MEMS including, but not limited to, a piezoelectric, piezoresistive, or capacitive type(s).

Power is supplied either by an internal battery or an external power source, ensuring continuous power to all pressure sensors. Output data from all sensors are written into a rolling memory to include pre-peak data. After a blast is sensed, recording is triggered, and data is stored on non-volatile memory including pre-peak data. The recorded blast data can be processed in the MCU or can be downloaded and post-processed after the event to determine the blast exposure severity. The quantitative amplitude of at least one blast parameter can be displayed with an indicator light and/or a digital display, and/or sent wirelessly to a mobile device, desktop computer, or server. The maximum pressure and/or acceleration recorded by any of the sensors (or an average or other mathematical computation of any combination, or all measured pressures), may be displayed, stored, or transmitted.

Processed data is recorded to a blast event memory which can be written to and read via either wired or wireless communication. In some instances of the invention, the blast event memory is co-located within the housing of the surrogate. In other instances of the invention, the blast event memory is located outside of the housing of the surrogate. The power consumption of the surrogate is minimized by utilizing low-power modes on the MCU and powering the pressure sensors only when the surrogate is in use.

The pressure history of all pressure sensors in the BOB and the data history from other blast parameter sensors in the BOB is analyzed and, at a minimum, the peak pressure and pressure impulse from all pressure sensors are calculated. The resultant pressure and directionality of the blast concerning the BOB can be determined with an analysis of the pressure history of each pressure sensor or a combination of sensors.

Metamaterials, specifically related to blast and acoustics, utilize engineered structures to influence the macroscopic properties of a system that are not naturally observed in the underlying materials. These properties include but are not limited to, wave speed, acoustic impedance, and frequency response. The unique construction of these metamaterials allows for the manipulation of how pressure waves propagate through the surrogate, thereby enabling the replication of human tissue system response under blast conditions with respect to the desired measurement location.

In the context of this invention, metamaterial construction involves creating complex structures using advanced 3D printing techniques. These structures can be designed with a reduced number of layers (n1), where n1 is less than the actual number of tissues (n) encountered by a pressure wave in a human system. The design of these layers is tailored to match the resultant system's acoustical properties, including wave speed, acoustic impedance, and attenuation. By carefully engineering the geometrical and material properties of these layers, it is possible to ensure that the measurement at a specific location (X) within the surrogate, after encountering n1 layers, closely matches the measurement at the same location (X) within a human system after encountering n tissues.

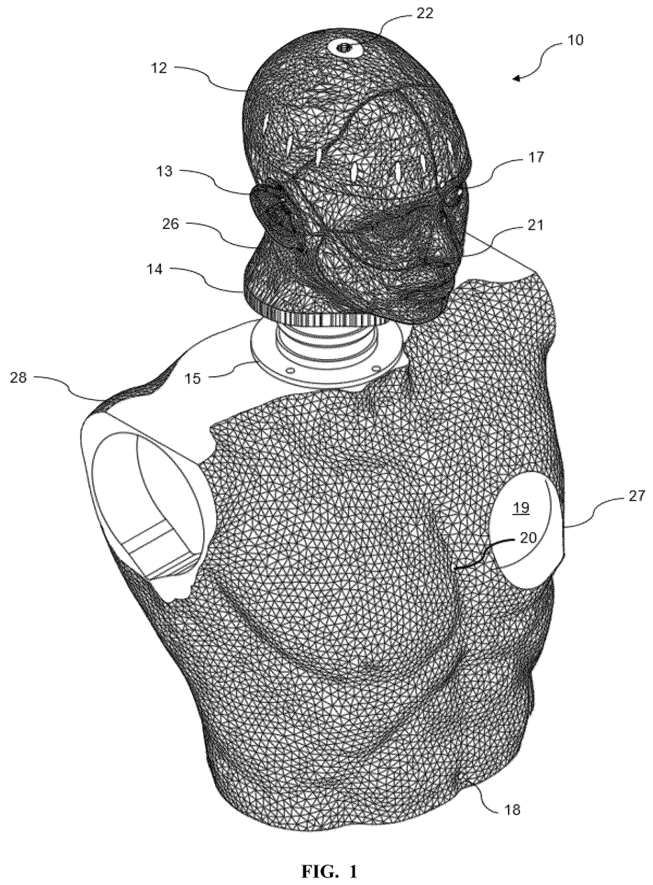

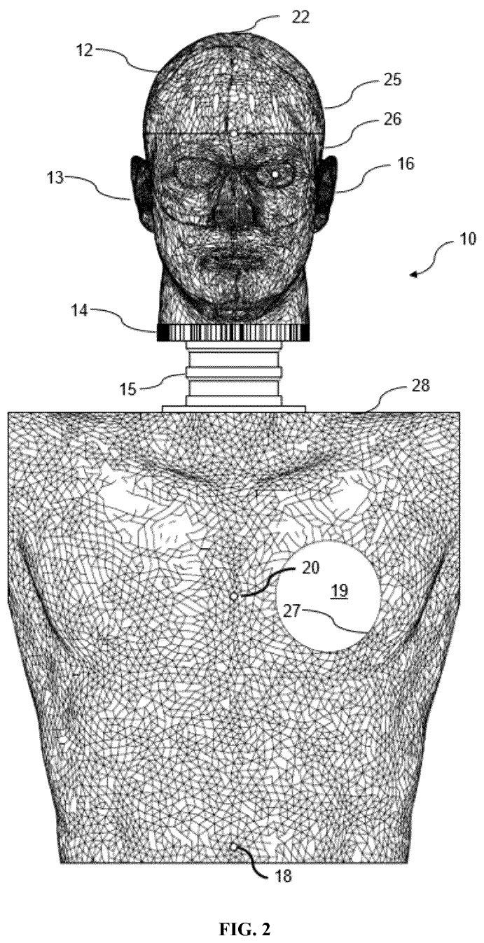

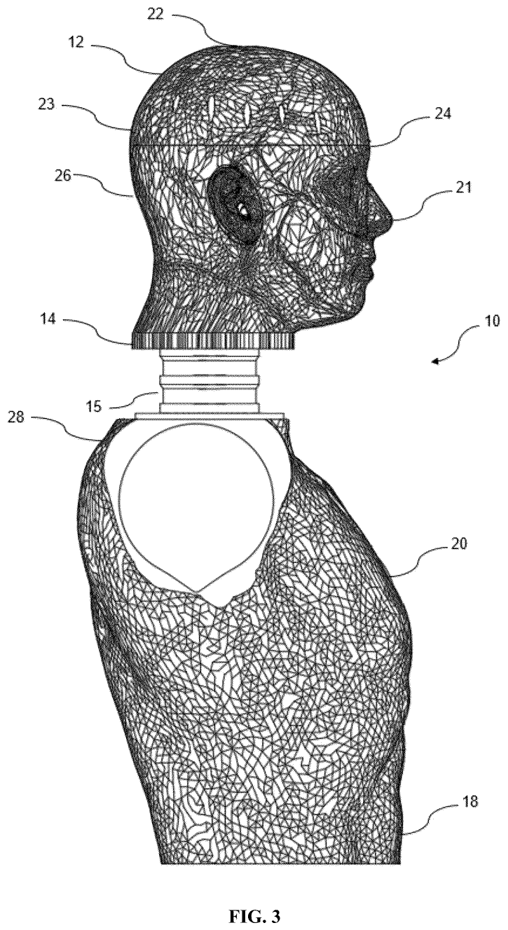

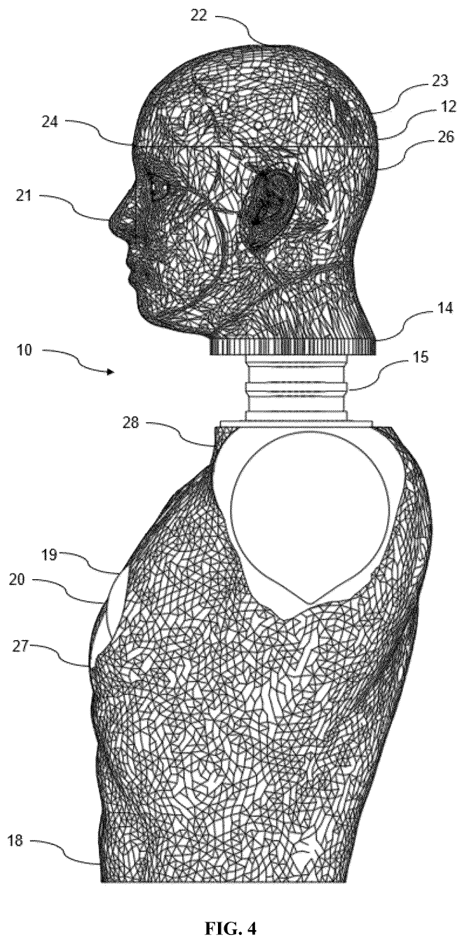

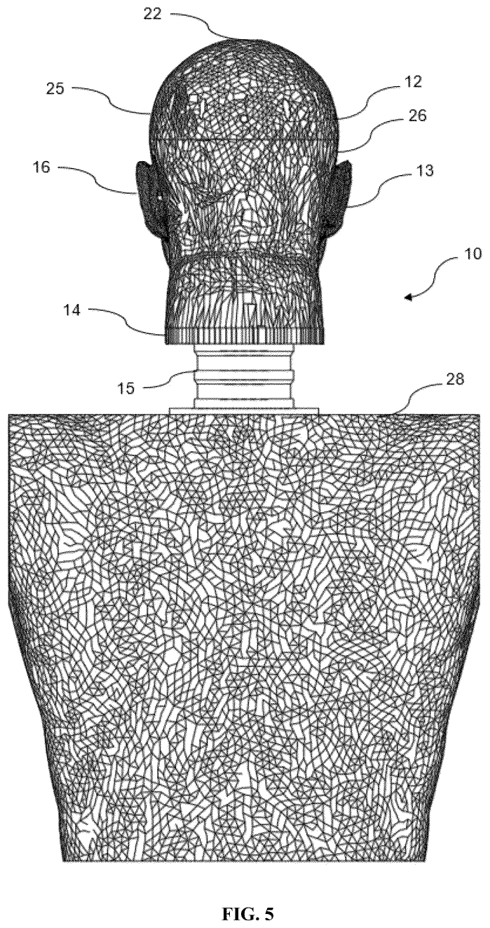

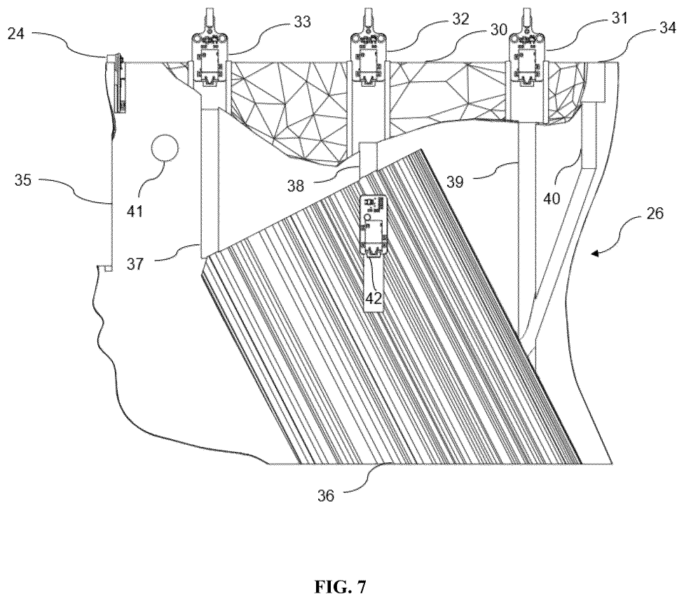

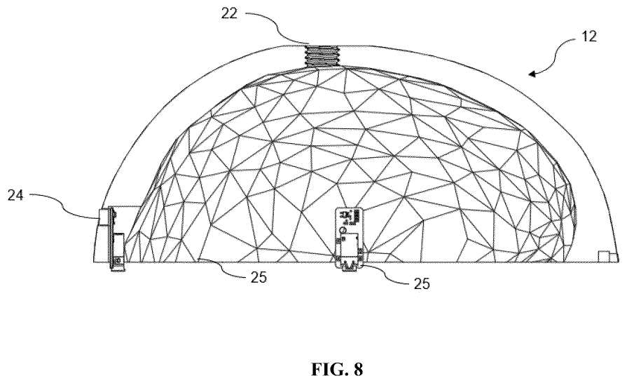

An illustrative instance of the BOB 10 of the present invention is shown in an isometric view in FIG. 1, a front view in FIG. 2, a right-side view in FIG. 3, a left-side view in FIG. 4, and a back-side view in FIG. 5. The BOB 10 is composed of a head with an upper portion 12 attached to the lower portion 26, connected to a neck 15 with an adapter 14, to the torso 28. As can be seen in FIGS. 1, 2, 3, 4, and 5, the upper 12 and lower 26 portions of the BOB head contain removable modular ears 16, 13, eye 17, and nose 21 with pressure sensors disposed on the forehead 24, back head 23, right ear 13, left eye 17, and left side of the head 25. Persons of ordinary skill in the art will appreciate that while the instance of the invention illustrated in FIGS. 1, 2, 3, 4, and 5 includes five non-in-brain pressure sensors 24, 23, 13, 17, and 25 on the head, other instances of the invention may contain fewer pressure sensors, a larger number of pressure sensors, or other types of sensors such as acceleration sensors. Also, present in the lower portion 26 BOB head as illustrated in FIG. 7 are three additional pressure sensor locations for in-brain pressure measurements located in the front-brain 33, mid-brain 32, and rear-brain 31, other instances of the invention may contain fewer in-brain pressure sensors or a larger number of pressure sensors in the same or different locations. As shown in FIGS. 7 and 8, the lower portion 26 of the BOB head includes the lower geometry of an anatomically brain cavity 30 which attaches to the upper portion of the head 12 with an anatomically correct upper brain cavity 29. Once the upper 12 and lower portion 26 of the head are assembled via bolts, glue, or other mechanical fastening means, filling of the combined anatomically correct brain cavity 29, 30 with any brain simulant material is accomplished with a threaded hole 22 that may be later plugged. Persons of ordinary skill in the art will appreciate that the simulated brain may be added via other means such as installing a completed brain system complete with ventricles, white and grey matter simulants, and suspended in simulated cerebrospinal fluid (CSF).

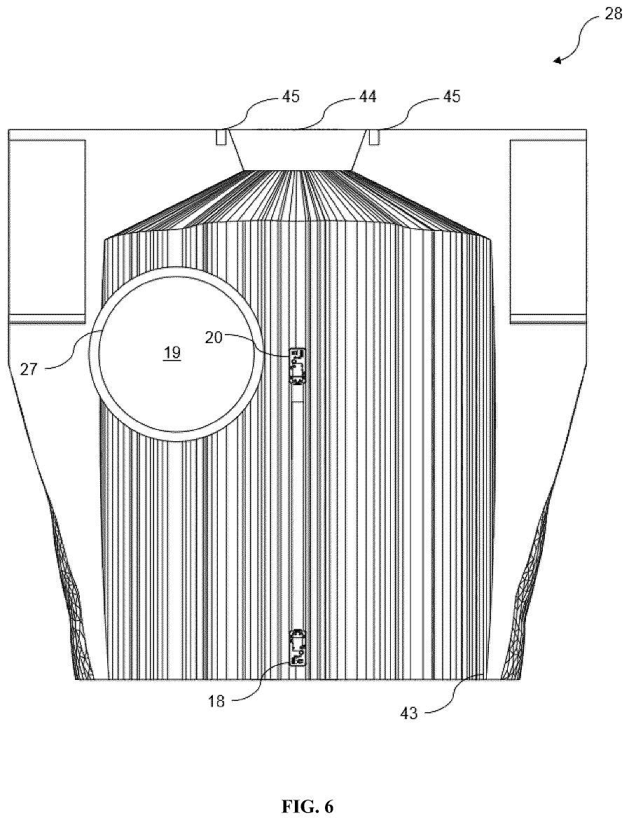

As shown in FIG. 6 the BOB torso 28 connects to the neck and head assembly with threaded fasteners 46, but persons of ordinary skill in the art will realize that the neck and/or head may be attached via other means such as with adhesives, interlocking geometry, or other mechanical means. In the illustrative example shown in FIG. 6 there is a channel 44 and void 43 for passing wires from the simplified simulated lung system 19, upper chest pressure sensor 27, and lower belly pressure sensor 18, other instances of the invention may contain fewer pressure sensors or a larger number of pressure sensors at various locations. The simplified simulated lung system 19 illustrated example is a polyurethane (PU) foam ball residing in a circular opening 27 containing the same remote sensor in the center used at other non-brain locations such as the upper chest 20. Persons of ordinary skill in the art will appreciate that while the instance of the PU foam ball simulated lung system 19 illustrated with a circular opening to the outside atmosphere 27, instances using other simulated lungs will readily suggest themselves, such as using any simulant lung system (with or without) an opening 27 of any geometry.

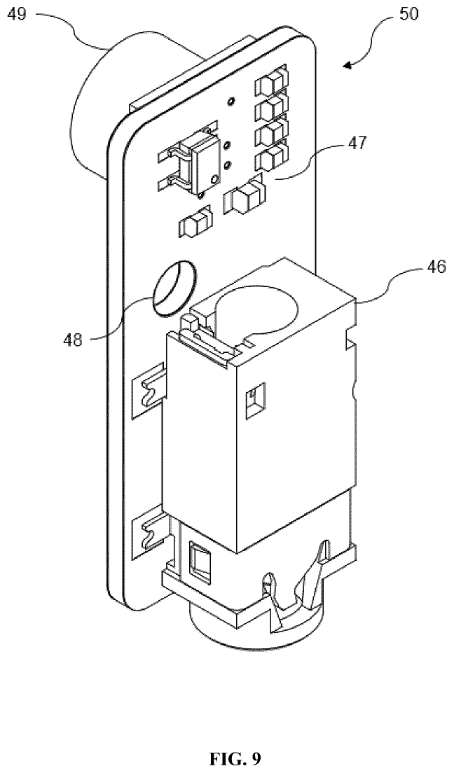

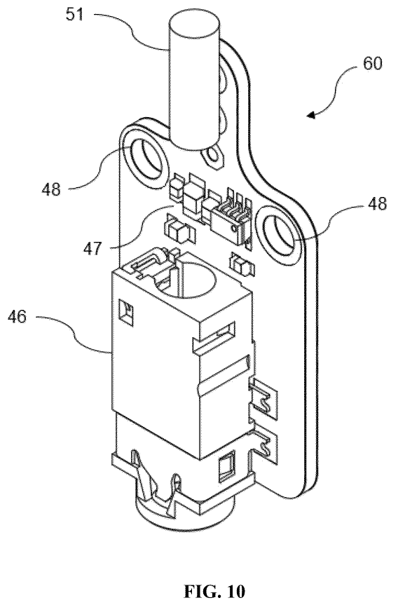

As shown in FIGS. 9 and 10, the remote sensing PCBs for non-in-brain 50 and in-brain measurements 60 have circuitry 47 for powering, filtering, and outputting signal from the sensing elements 49 and 50 via female audio jacks 46, with at least one mounting hole 48 for mounting in the invention 10.

As shown in FIGS. 9, 10, and 11, the remote sensing PCBs for in-brain 60 and non-in-brain 50 measurements connect to the main controller data acquisition PCB 70 via standardized female audio connector jacks 46 using male-to-male cables. Persons of ordinary skill in the art will appreciate that while the instance of the invention illustrated uses female 3.5 mm connector jacks 46, any standard or custom cabling and connectors providing at least power, ground, and signal lines could be used.

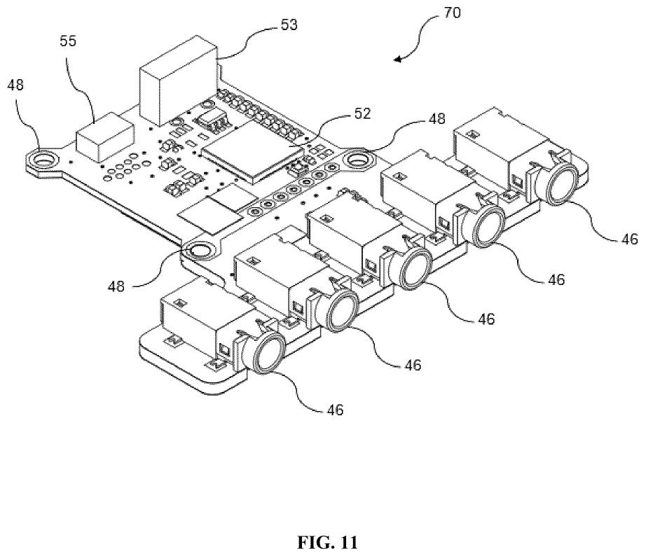

Referring now to FIG. 11, the main controller data acquisition PCB 70 contains the necessary circuitry and hardware for triggering, recording, storing event data, and wirelessly communicating the collected data via Bluetooth or Wi-Fi using a wireless integrated System on a Chip (SoC) microcontroller 52 and via hardware connection with USB-C 53.

Persons of ordinary skill in the art will appreciate that while the instance of the invention illustrated uses a USB-C port 53 for wired data transfer and an SoC 52 for Wi-Fi and Bluetooth, other components and modules for wired data transfer, Wi-Fi, and Bluetooth would readily suggest themselves. The main controller data acquisition PCB 70 also contains mounting holes 48, the electronics for charging a battery with the USB-C plug 53 and connects to a battery with a standardized JST battery connector 55.

The main controller data acquisition PCB 70 and the battery can be placed anywhere on or in the invention 10 in a separate housing or integrated into the invention itself. The illustrative example of the main controller data acquisition PCB 70 is disposed with 5 female audio connectors 46 for connection of up to 5 remote sensing boards of any type 60, 50, but can contain fewer or more connectors 46 for sensor channels.

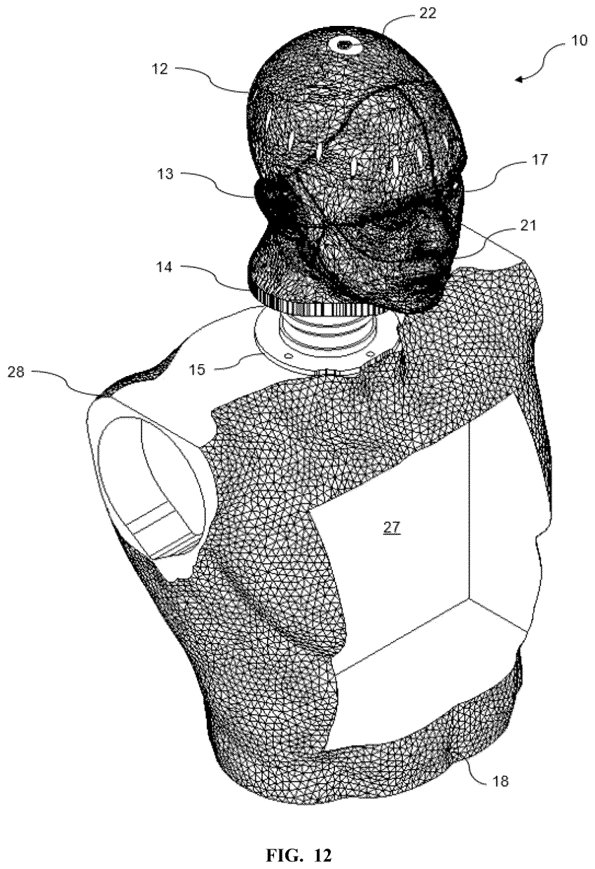

As shown in FIG. 12 the illustrative instance of the BOB 10 shows the opening 27 to the outside atmosphere of the torso 28 to be a rectangular cavity. Persons of ordinary skill in the art will appreciate that this opening enables flexibility for alternate instances that readily suggest themselves, such as other simulant lungs, torso organs, ribcage, or ballistic simulant systems for enhancing capability for any test need. Persons of ordinary skill in the art will appreciate that this design intent illustrated here could be of any geometry in any location on the BOB 10 such that other organs and systems could be accommodated for any other testing need.

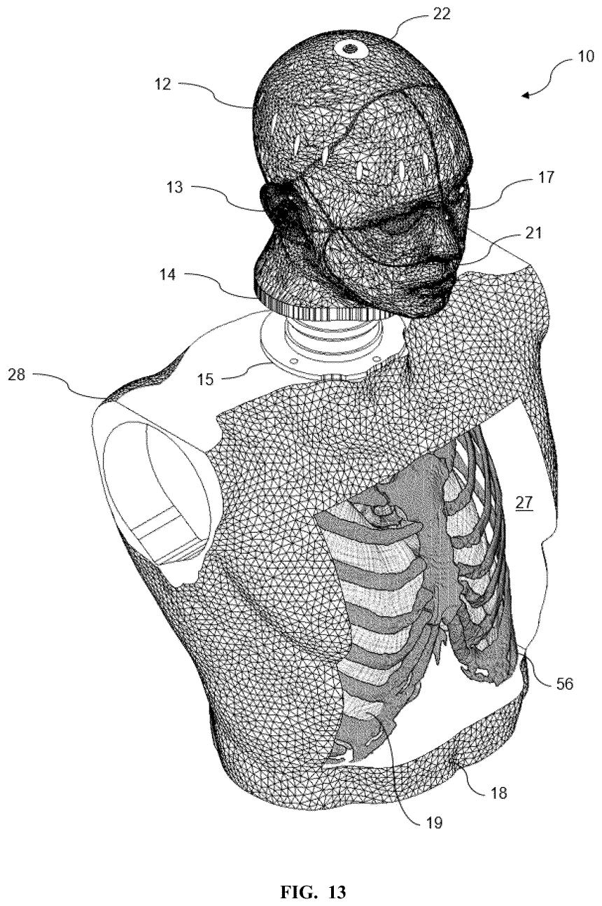

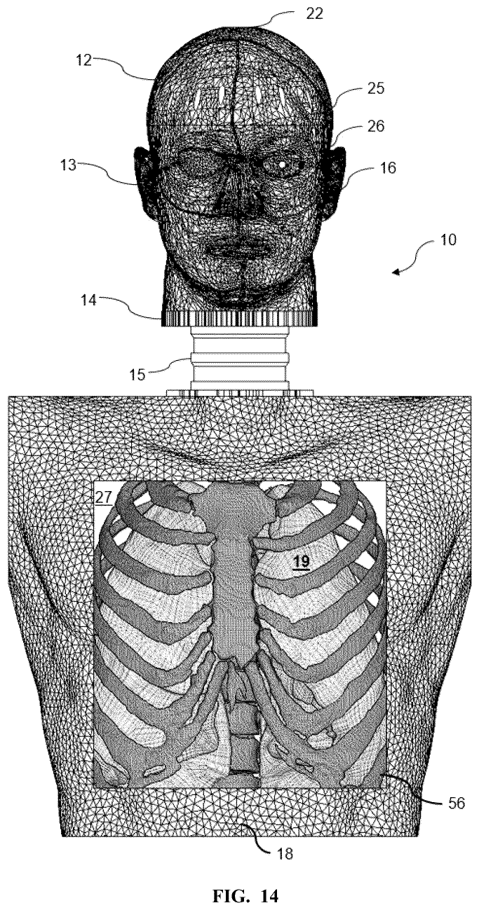

As shown in FIGS. 13 and 14, the illustrative instances of the BOB 10 show the opening 27 to the outside atmosphere of the torso 28 to be a rectangular cavity containing an anatomically correct simulated lung system 19 disposed behind an anatomically correct ribcage assembly 56. Persons of ordinary skill in the art will appreciate that this example with opening 27 may also be closed with muscle and/or skin simulant systems such that the BOB 10 contains no opening 27 for testing purposes. Persons of ordinary skill in the art will appreciate intent illustrated here could be of any geometry in any location on the BOB 10 such that other organs and systems could be accommodated for any other testing need.

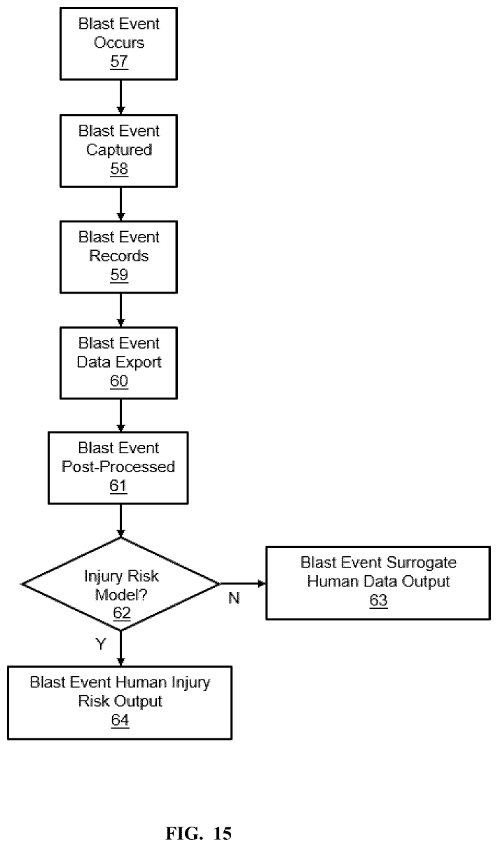

The operational concept for the BOB 10 is illustrated in FIG. 15. A blast event 57 occurs and the BOB 10 captures the blast event parameters from multiple organ sensors at 58 and is written to non-volatile memory at 59. The blast data is exported via wired connection or wireless connection at 60 where it can be post-processed to correct data and/or analyzed to report key metrics via a BOB 10 software 61. The post-processed data can be used by the user at 63 as surrogate human data, or used in an injury risk model 62 to output human blast injury risk for the event at 64.

What is claimed is:

1. An anatomically correct, sensor-integrated male and female blast surrogate for testing and evaluating personal protective equipment (PPE) and environments, comprising:
an anatomically correct head and torso with organs,
multiple integrated sensors for capturing blast pressure and/or acceleration data at various locations, including in the brain,
a controller for processing and storing the data,
a modular design allowing for easy replacement of damaged parts or alternate configurations, and
a power supply for powering the electronic circuitry.

2. The surrogate of claim 1, wherein the surrogate is manufactured using 3D printing techniques, allowing for low-cost production and replication of complex anatomical structures and tissues.

3. The surrogate of claim 2, wherein the surrogate is manufactured using 3D printing techniques to create structures with a reduced number of layers (n1), where n1 is less than the actual number of tissues (n) encountered by a pressure wave in a human system. These layers are designed to match the resultant system acoustical properties, including but not limited to wave speed, acoustic impedance, and attenuation, ensuring that the measurement at a specific location (X) within the surrogate after encountering n1 layers closely matches the measurement at the same location (X) within a human system after encountering n tissues, in terms of wave shape including rise time, decay time, impulse and amplitude.

4. The surrogate of claim 2 or claim 3, wherein the metamaterial construction results in time-pressure waveforms that closely match those observed in cadaver and human models for specific organ or system measurements, including but not limited to the brain.

5. The surrogate of claim 1, wherein the blast data is processed and modified by computational algorithms and/or functions to match human blast response more closely, including but not limited to signal filtering, data interpolation, and correction techniques.

6. The surrogate of claim 5, wherein the computational algorithms and functions include known mathematical models, machine learning-based algorithms, and/or adaptive learning systems capable of updating and refining the data modification based on real-time feedback and additional data inputs.

7. The surrogate of claim 1, wherein the surrogate's head contains an anatomically correct brain cavity designed to accommodate any brain simulant material or system.

8. The surrogate of claim 1, wherein the surrogate is designed to capture at minimum multiple channels of time-synchronized pressure data for a blast event and is also capable of integrating and capturing data from any additional sensors, including but not limited to acceleration, temperature, and force sensors.

9. The surrogate of claim 1, wherein the surrogate components are designed to be easily replaceable, allowing for the replacement of damaged parts or alternative configurations.

10. The surrogate of claim 1, wherein the surrogate is designed to provide blast data that is comparable to human models and cadaver tests in both the magnitude and shape of the waveforms.

11. The surrogate of claim 1, wherein the surrogate is designed to provide automated injury risk assessment and notification to the operator, indicating the potential human injury risk based on recorded data and a predefined injury risk model.

12. The surrogate of claim 1, wherein the surrogate is manufactured using other manufacturing techniques and/or a combination of manufacturing techniques such as, but not limited to injection molding, blow molding, casting, and thermoplastic and thermoform molding, allowing production and replication of complex anatomical structures and tissues.

13. The surrogate of claim 1, wherein the blast data is sent wirelessly or via a physical connection to a mobile device, computer, or server.

14. The surrogate of claim 1, wherein the surrogate is powered by an onboard battery, either rechargeable or replaceable, or by an external power source.

15. The surrogate of claim 1, wherein the surrogate is designed to trigger a blast event based on data from at least one sensor, and all sensors record at the same time with a rolling buffer to include pre-peak data.

16. The surrogate of claim 2, wherein the 3D printing manufacturing method is fused deposition modeling (FDM), selective laser sintering (SLS), or stereolithography (SLA), and allows for the use of any 3D printable materials such as, but not limited to, polylactic acid (PLA), nylon, polyethylene terephthalate glycol (PETG), thermoplastic polyurethane (TPU), acrylonitrile butadiene styrene (ABS), including fiber and/or particle reinforced combinations, or any SLA resin, either commercial or proprietary.

17. The surrogate of claim 1, wherein the surrogate is designed to provide a single device solution for the collection of blast and acceleration data from a single blast at various locations for injury risk assessment.

18. A method for operating the surrogate of claim 1, comprising:
affixing the surrogate to an object or stand,
continually sensing pressure data from the pressure sensors,
continuously storing the sensed pressure data in a rolling memory buffer in the surrogate,
comparing in the surrogate the sensed data from the sensors with a preset threshold,
identifying in the surrogate sensed data that exceeds the preset threshold as blast event data, and
in response to identifying blast event data, writing a data set from the rolling memory buffer into a blast event memory in the surrogate, the data set including sensed data stored sequentially from a time prior to the blast event data to sensed data stored from a time after the blast event data.

19. A method for operating the surrogate of claim 1, comprising:
affixing individual components of the surrogate to test stands and/or crash test dummy parts for blast testing,
installing personal protective equipment (PPE) onto the surrogate to evaluate performance during blast events,
mounting weapon systems or other relevant equipment onto the surrogate for integrated testing scenarios,
ensuring secure attachment and alignment of surrogate components to replicate realistic blast conditions accurately, and
using the surrogate in simulated operational or operational environments.

20. The surrogate of claim 1, wherein the surrogate includes a customizable interface allowing users to adjust and configure sensor placements and data processing parameters to suit specific testing scenarios.
